(19) United States
(12) Patent Application Publication
(10) Pub. No.: US 2017/0177435 A1
(43) Pub. Date: Jun. 22, 2017

(54) Sharing Memory Between Processors in a Wireless Sensor Device

(71) Applicant: Cognitive Systems Corp., Waterloo (CA)

(72) Inventors: Karanvir Chattha, Waterloo (CA); William Suriaputra, Waterloo (CA); Nebu John Mathai, Waterloo (CA)

(73) Assignee: Cognitive Systems Corp., Waterloo, ON (CA)

(21) Appl. No.: 14/971,162

(22) Filed: Dec. 16, 2015

(51) Int. Cl. G06F 11/10; H04B 1/06; H04L 1/00

(52) U.S. Cl. CPC G06F 11/1016; H04L 1/004; H04B 1/06

(57) ABSTRACT

In some cases, a wireless sensor device includes a radio frequency (RF) processor system. The RF processor system includes a forward error correction (FEC) device, a digital signal processor (DSP) device and a shared memory device that is connected between the FEC device and the DSP device. The DSP device is directly connected to the shared memory device and configured to selectively access individual memory elements of the shared memory device. The FEC device is directly connected to the shared memory device and configured to collectively access arrays of memory elements of the shared memory device.

### BACKGROUND

The following description relates to sharing memory between processors in a wireless sensor device.

Wireless devices often include multiple processors. For example, a wireless device may include a digital signal processor that processes digital signals and a forward error correction processor that corrects errors in digital signals. Processors in a wireless device can, in some cases, communicate with each other or with other components in the wireless device.

### SUMMARY

In a general aspect of what is described here, a memory device is connected between two processor devices in a wireless sensor device.

In some aspects, a wireless sensor device includes a radio frequency (RF) processor system. The RF processor system includes a shared memory device that is connected between a forward error correction (FEC) device and a digital signal processor (DSP) device. The DSP device is directly connected to the shared memory device and configured to selectively access individual memory elements of the shared memory device. The FEC device is directly connected to the shared memory device and configured to collectively access arrays of memory elements of the shared memory device.

In some aspects, a shared memory device receives, from a forward error correction (FEC) device, a first request to selectively access an individual memory element of the shared memory device. The shared memory device provides the FEC device access to the individual memory element in response to the first request. The shared memory device receives, from a digital signal processor (DSP) device, a second request to collectively access an array of memory elements of the shared memory device. The shared memory device provides the DSP device access to the array of memory elements in response to the second request.

Implementations of these and other aspects may include one or more of the following features. The RF processor system can include a translator unit that translates memory address information between the FEC device and the shared memory device. The translator unit can be included in the FEC device or the shared memory device, or it may be implemented in another device. The shared memory device can include a matrix of memory elements; the DSP device can access individual memory elements in the matrix; and the FEC device can collectively access rows or columns of memory elements in the matrix.

Implementations of these and other aspects may include one or more of the following features. The wireless sensor device can include an antenna system configured to wirelessly receive radio frequency (RF) signals. The wireless sensor device can include processor paths that transfer the RF signals from the antenna system to the RF processor system.

Implementations of these and other aspects may include one or more of the following features. The RF processor system can include multiple shared memory devices connected between multiple FEC devices and multiple DSP devices. Each DSP device can be directly connected to each of the shared memory devices and configured to selectively access individual memory elements of the shared memory devices. Each FEC device can be directly connected to each of the shared memory devices and configured to collectively access arrays of memory elements of the shared memory devices.

Implementations of these and other aspects may include one or more of the following features. The first request to selectively access the individual memory element can be a request to write information to the individual memory element or a request to read information from the individual memory element. The second request to collectively access the array of memory elements can be a request to write information to the array of memory elements or a request to read information from the array of memory elements.

The details of one or more implementations are set forth in the accompanying drawings and the description below. Other features, objects, and advantages will be apparent from the description and drawings, and from the claims.

### DESCRIPTION OF DRAWINGS

FIG. 1A is a block diagram showing an example wireless sensor device.

FIG. 1B is a schematic diagram showing an example processor system.

FIG. 2 is a schematic diagram showing another example processor system.

FIG. 3 is a schematic diagram showing an example signal path in a wireless sensor device.

### DETAILED DESCRIPTION

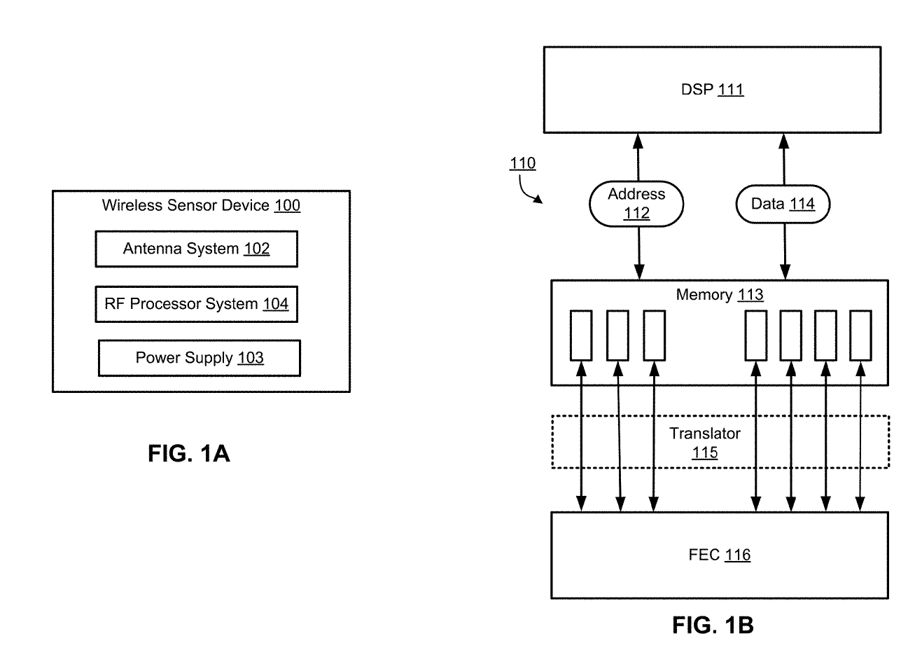

FIG. 1A is a block diagram showing an example wireless sensor device 100. As shown in FIG. 1A, the wireless sensor device 100 includes an antenna system 102, a radio frequency (RF) processor system 104 and a power supply 103. A wireless sensor device may include additional or different features and components, and the components can be arranged as shown or in another manner.

In operation, the wireless sensor device 100 can detect and analyze wireless signals. In some implementations, the wireless sensor device 100 can detect signals exchanged according to a wireless communication standard (e.g., for a cellular network), although the wireless sensor device itself is not part of the cellular network. In some instances, the wireless sensor device 100 monitors RF signals by “listening” or “watching” for RF signals over a broad range of frequencies and processing the RF signals that it detects. There may be times when no RF signals are detected, and the wireless sensor device 100 may process RF signals (e.g., from time to time or continuously) as they are detected in the local environment of the wireless sensor device 100.

The example antenna system 102 is communicatively coupled with the RF processor system 104, for example, by wires, leads, contacts or another type of coupling that allows the antenna system 102 and the RF processor system 104 to exchange RF signals. In some instances, the antenna system 102 wirelessly receives RF signals from the electromagnetic environment of the wireless sensor device 100 and transfers the RF signals to the RF processor system 104 to be processed (e.g., digitized, analyzed, stored, retransmitted, etc.). In some instances, the antenna system 102 receives RF signals from the RF processor system 104 and wirelessly transmits the RF signals from the wireless sensor device 100.

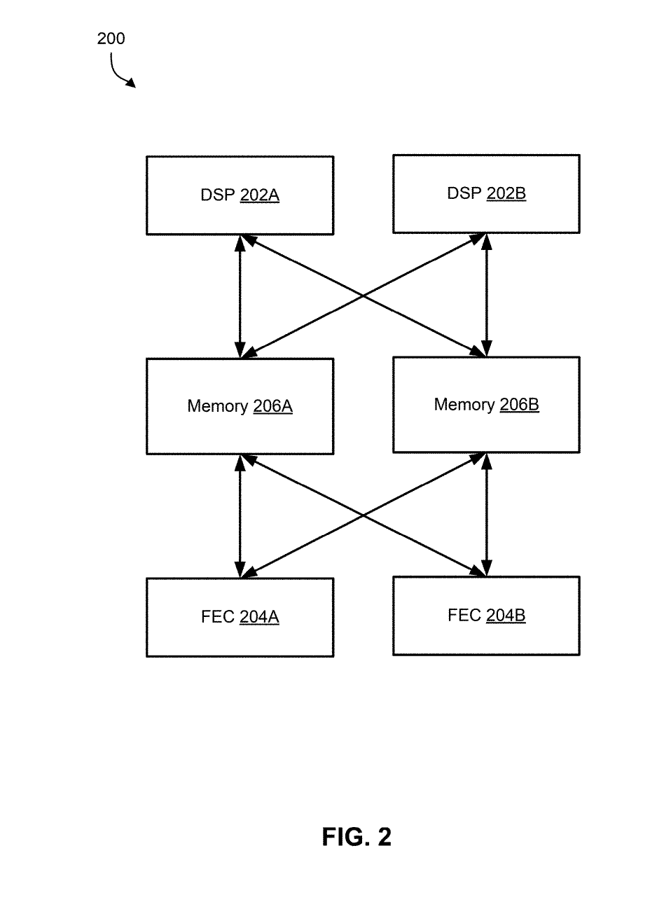

The example RF processor system 104 can include one or more chips, chipsets, or other types of devices that are configured to process RF signals. For example, the RF processor system 104 may include one or more processor devices that are configured to identify and analyze data encoded in RF signals by demodulating and decoding the RF signals transmitted according to various wireless communication standards. In some cases, the RF processor system 104 can include one or more digital signal processor (DSP) devices, forward error correction (FEC) devices and possibly other types of processor devices. In some cases, the RF processor system 104 can include a shared memory device that is connected between disparate processor devices. For example, the RF processor system 104 may include the processor system 110 shown in FIG. 1B, the processor system 200 shown in FIG. 2, or another type of processor system.

In some cases, the example RF processor system 104 can operate as a high performance vector processor for waveform processing. For instance, the RF processor system 104 can include a DSP device that performs waveform-level modem computation, an FEC device that performs forward error correction and possibly other types of dedicated processors. The FEC device can be implemented as a dedicated variable FEC device that can handle multiple standards (e.g., Turbo codes, Viterbi algorithms, Low Density Parity Check (LDPC) codes) with variable parameters.

In some cases, the RF processor system 104 includes an FEC device and DSP device that operate together to process radio signals in accordance with one or more radio standards, and a memory device in the RF processor system 104 passes data between the FEC device and the DSP device during operation. For example, data can be exchanged between an FEC algorithm executed by the FEC device and lower-level operations (transpositions, interleaving, etc.) executed by the DSP device. In some implementations, data can be passed between the FEC device and the DSP device without using or accessing a direct memory access (DMA) device. For instance, data can be exchanged between the FEC device and the DSP device through a shared memory device, for example, as shown in FIGS. 1B and 2, or in another manner.

In some cases, the RF processor system 104 includes a DSP device that uses linear memory and an FEC device that uses vector or matrix memory, and the DSP device and FEC device can exchange data through a single shared memory device. For instance, the DSP device can access the shared memory device as a linear memory and the FEC device can access the shared memory device as a vector or matrix memory. In some cases, the RF processor system 104 uses an address translation scheme that enables the FEC device to view its random access memory (RAM) as a matrix, while the DSP device can view the same RAM linearly. For example, the translation scheme can provide a custom view of the RAM based on the memory access pattern of the FEC device, while the DSP device can access the RAM without translation. In some cases, the shared memory device can improve the efficiency of the RF processor system 104, for example by allowing the DSP device and the FEC device to operate in a high throughput mode without stalls, and by allowing the RF processor system 104 to operate with less memory resources.

In some implementations, the RF processor system 104 is configured to monitor and analyze signals that are formatted according to one or more communication standards or protocols, for example, 2G standards such as Global System for Mobile (GSM) and Enhanced Data rates for GSM Evolution (EDGE) or EGPRS; 3G standards such as Code Division Multiple Access (CDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); wireless local area network (WLAN) or WiFi standards such as IEEE 802.11, Bluetooth, near-field communications (NFC), millimeter communications; or multiple of these or other types of wireless communication standards. In some cases, the RF processor system 104 is capable of extracting all available characteristics, synchronization information, cells and services identifiers, quality measures of RF, physical layers of wireless communication standards and other information. In some implementations, the RF processor system 104 is configured to process other types of wireless communication (e.g., non-standardized signals and communication protocols).

In some implementations, the RF processor system 104 can perform various types of analyses in the frequency domain, the time domain, or both. In some cases, the RF processor system 104 is configured to determine bandwidth, power spectral density, or other frequency attributes of detected signals. In some cases, the RF processor system 104 is configured to perform demodulation and other operations to extract content from the wireless signals in the time domain such as, for example, signaling information included in the wireless signals (e.g., preambles, synchronization information, channel condition indicator, SSID/MAC address of a WiFi network). The RF processor system 104 and the antenna system 102 can operate based on electrical power provided by the power supply 103. For instance, the power supply 103 can include a battery or another type of component that provides an AC or DC electrical voltage to the RF processor system 104.

In some cases, the wireless sensor device 100 is implemented a compact, portable device that can be used to sense wireless signals and analyze wireless spectrum usage. In some implementations, the wireless sensor device 100 is designed to operate with low power consumption (e.g., around 0.1 to 0.2 Watts or less on average). In some implementations, the wireless sensor device 100 can be smaller than a typical personal computer or laptop computer and can operate in a variety of environments. In some instances, the wireless sensor device 100 can operate in a wireless sensor network or another type of distributed system that analyzes and aggregates wireless spectrum usage over a geographic area. For example, in some implementations, the wireless sensor device 100 can be used as described in U.S. Pat. No. 9,143,168, entitled, “Wireless Spectrum Monitoring and Analysis,” or the wireless sensor device 100 can be used in another type of environment or operate in another manner.

FIG. 1B is a schematic diagram showing an example processor system 110. In some cases, the processor system 110 can be included in the RF processor system 104 shown in FIG. 1A. For example, the processor system 110 may be configured to receive and analyze RF signals detected by an antenna system. The processor system 110 can be included in other types of systems and devices. The example processor system 110 in FIG. 1B includes a digital signal processor (DSP) device 111, a memory device 113, a translator unit 115 and a forward error correction (FEC) device 116. In some examples, the components shown in FIG. 1B can be integrated on a chip. The processor system 110 may include additional or different features, and the features of a processor system may be arranged as shown or in another manner.

The example DSP device 111 is a data processor that performs digital signal processing operations. For instance, the DSP device 111 can perform filtering operations, transformation operations, compression operations or other types of digital signal processing operations. In some cases, the DSP device 111 can be used to interpret, analyze, measure or otherwise process radio frequency (RF) messages that have been received wirelessly by a wireless sensor device.

In the example shown in FIG. 1B, the DSP device 111 is directly connected to the memory device 113. For example, the DSP device 111 may be connected to the memory device 113 by a data bus or interconnect, and the DSP device 111 can communicate directly with the memory device 113 (e.g., independent of a separate memory or a memory access device such as a DMA controller). In the example shown in FIG. 1B, the DSP device 111 is configured to selectively access individual memory elements of the memory device 113. For example, the DSP device 111 may read data from a byte of physical memory in the memory device 113, or the DSP device 111 may write data to a byte of physical memory in the memory device 113.

The example FEC device 116 is a data processor that corrects errors in a received data transmission. For instance, the FEC device 116 can receive a message that has been encoded by another device (e.g., using an error correcting code). The FEC device 116 can use a decoding algorithm to detect and correct errors in the message (e.g., errors introduced during transmission over a noisy channel). For instance, the FEC device 116 can decode the message using a standard decoding algorithm (e.g., Turbo, Viterbi, Low Density Parity Check (LDPC), etc.). In some cases, the FEC device can be implemented as a dedicated variable FEC device that can handle multiple standards with variable parameters.

In the example shown in FIG. 1B, the FEC device 116 is directly connected to the memory device 113. For example, the FEC device 116 may be connected to the memory device 113 by a data bus or interconnect, and the FEC device 116 can communicate directly with the memory device 113 (e.g., independent of a separate memory or a memory access device such as a DMA controller). In the example shown in FIG. 1B, the FEC device 116 is configured to collectively access arrays of memory elements of the memory device 113. For example, the FEC device 116 may read data from a row or column of physical memory in the memory device 113, or the DSP device 111 may write data to a row or column of physical memory in the memory device 113.

The example memory device 113 is a shared memory device connected between the FEC device 116 and the DSP device 111. The shared memory device 113 includes a matrix of memory elements. Each memory element can be, for example, a byte or other unit of physical memory. The example DSP device 111 is configured to access individual memory elements in the matrix, while the example FEC device 116 is configured collectively accesses rows or columns of memory elements in the matrix. In some implementations, the example DSP device 111 can access information stored in the memory device 113 by accessing individual memory elements in the matrix without accessing other memory elements (e.g., other memory elements in the same row or column), while the example FEC device 116 can access information stored in the memory device 113 only by accessing the multiple memory elements in a row or a column of the matrix.

The translator unit 115 can translate memory address information between the FEC device 116 and the memory device 113. The translation performed by the translator unit 115 can allow the FEC device to accesses rows or columns of memory elements in the memory device 113. For example, the translator unit 115 may translate a row or column address from the FEC device 116 to individual memory addresses in the memory device 113. The translator unit 115 can be integrated with another device (e.g., implemented within the memory device 113, within the FEC device 116) or the translator unit can be implemented as a separate unit apart from other components of the processor system 110.

In some aspects of operation, the DSP device 111 generates a request to selectively access an individual memory element of the memory device 113. The memory device 113 can then provide the DSP device 111 access to the individual memory element in response to the request. As an example, the DSP device 111 may request to read information from the individual memory element by sending a memory address 112 to the memory device 113, and the memory device 113 may respond by sending data 114 from the memory address to the DSP device 111. As another example, the DSP device 111 may request to write information to the individual memory element by sending data 114 to the memory device 113, and the memory device 113 may write the data to a specified memory address 112.

In some aspects of operation, the FEC device 116 generates a request to collectively access an array of memory elements of the memory device 113. The memory device 113 can then provide the FEC device 116 access to the array of memory elements in response to the request. As an example, the FEC device 116 may request to read information from a row or column of memory elements. The translator unit 115 may translate the address information for the row or column to address information for multiple memory elements in the memory device 113, and the memory device 113 may then send data from memory elements to the FEC device 116. As another example, the FEC device 116 may request to write information to a row or column of memory elements, and the memory device 113 may write the data to a specified row or column.

FIG. 2 is a schematic diagram showing another example processor system 200. In some cases, the processor system 200 can be included in the RF processor system 104 shown in FIG. 1A. For example, the processor system 200 may be configured to receive and analyze RF signals detected by an antenna system. The processor system 200 can be included in other types of systems and devices. The example processor system 200 in FIG. 2 includes digital signal processor (DSP) devices 202A, 202B, memory devices 206A, 206B, and forward error correction (FEC) devices 204A, 204B. The processor system 200 may include additional or different features, and the features of a processor system may be arranged as shown or in another manner.

In the example shown in FIG. 2, the memory devices 206A, 206B are both shared memory devices that are connected between the FEC devices 204A, 204B and the DSP devices 202A, 202B. Each DSP device 202A, 202B is directly connected to the memory devices 206A, 206B and configured to selectively access individual memory elements of the shared memory devices 206A, 206B. For example, each DSP device 202A, 202B can independently interact with each memory device 206A, 206B as the DSP device 111 interacts with the memory device 113 in FIG. 1B. Each FEC device 204A, 204B is directly connected to the shared memory devices 206A, 206B and configured to collectively access arrays of memory elements of the shared memory devices 206A, 206B. For example, each FEC device 204A, 204B can independently interact with each memory device 206A, 206B as the FEC device 116 interacts with the memory device 113 in FIG. 1B.

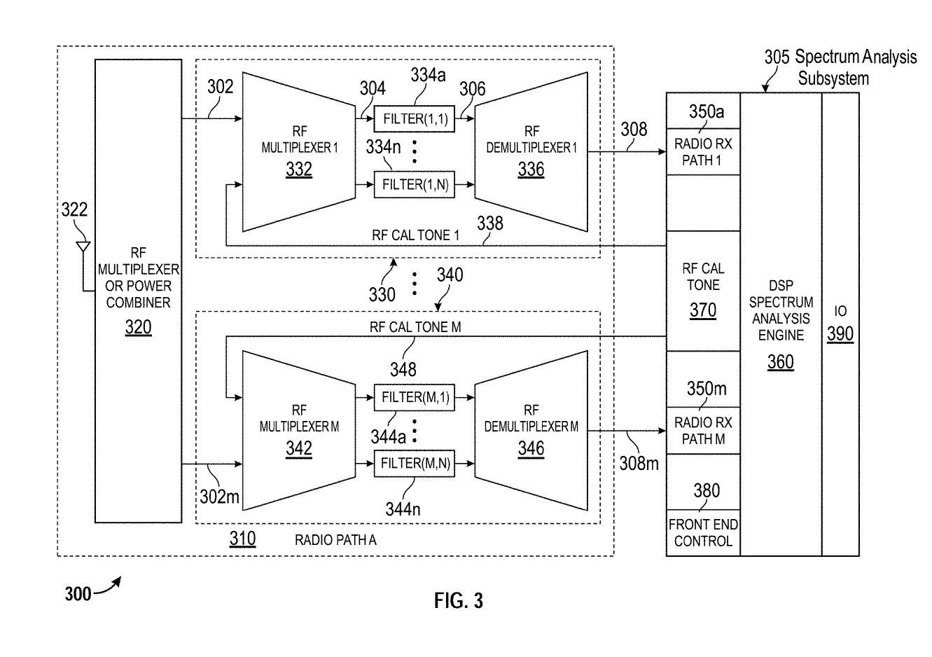

FIG. 3 is a schematic diagram showing an example signal path 300 that can be implemented in a wireless sensor device. Other types of signal paths may be used for processing signals in a wireless sensor device. The example signal path 300 shown in FIG. 3 includes an RF interface 310 (denoted as “Radio Path A” in FIG. 3) and a spectrum analysis subsystem 305. A signal path can include additional or different features, which may be configured as shown or in another manner. In some cases, the system shown in FIG. 3 can perform all operations for monitoring and analyzing wireless signals in a wireless sensor device. For example, the signal path 300 can perform functions of a wireless receiver such as demodulation, equalization, channel decoding, etc. The signal path 300 can support signal reception of various wireless communication standards and access the spectrum analysis subsystem 305 for analyzing the wireless signals.

In the example shown, the RF interface 310 can include a wideband or narrowband front-end chipset for detecting and processing RF signals. For example, the RF interface 310 can be configured to detect RF signals in a wide spectrum of one or more frequency bands, or a narrow spectrum within a specific frequency band of a wireless communication standard. In some implementations, the signal path 300 can include one or more RF interfaces 310 to cover the spectrum of interest.

In the example shown in FIG. 3, the RF interface 310 includes an antenna system 322, an RF multiplexer 320 or power combiner (e.g., an RF switch), and one or more signal processing paths (e.g., “path 1” 330, . . . , “path M” 340). The example antenna system 322 in FIG. 3 is connected to the RF multiplexer 320. In some implementations, the RF interface 310 can be configured to use the antenna system 322 for detecting the RF signals based on single-input single-output (SISO), single-input and multiple-output (SIMO), multiple-input and single-output (MISO), or multiple-input and multiple-output (MIMO) technologies.

In some implementations, an RF signal in the local environment of a wireless sensor device can be picked up by the antenna system 322 and input into the RF multiplexer 320. Depending on the frequency of the RF signal, the signal 302 output from the RF multiplexer 320 can be routed to one of the processing paths (i.e., “path 1” 330, . . . , “path M” 340, where M is an integer). Each path can include a distinct frequency band. For example, “path 1” 330 may be used for RF signals between 1 GHz and 1.5 GHz, while “path M” may be used for RF signals between 5 GHz and 6 GHz. The multiple processing paths may have a respective central frequency and bandwidth. The bandwidths of the multiple processing paths can be the same or different. The frequency bands of two adjacent processing paths can be overlapping or disjointed. In some implementations, the frequency bands of the processing paths can be allocated or otherwise configured based on the assigned frequency bands of different wireless communication standards (e.g., GSM, LTE, WiFi, etc.). For example, it can be configured such that each processing path is responsible for detecting RF signals of a particular wireless communication standard. As an example, “path 1” 330 may be used for detecting LTE signals, while the “path M” 340 may be used for detecting WiFi signals.

Each processing path (e.g., “processing path 1” 330, “processing path M” 340) can include one or more RF passive and RF active elements. For example, the processing path can include an RF multiplexer, one or more filters, an RF de-multiplexer, an RF amplifier, and other components. In some implementations, the signals 302, 302m output from the RF multiplexer 320 can be applied to a multiplexer in a processing path (e.g., “RF multiplexer 1” 332, . . . , “RF multiplexer M” 342). For example, if “processing path 1” 330 is selected as the processing path for the signal 302, the signal 302 can be fed into “RF multiplexer 1” 332. The RF multiplexer can choose between the signal 302 coming from the first RF multiplexer 320 or the RF calibration (cal) tone 338 provided by the spectrum analysis subsystem 305. The output signal 304 of “RF multiplexer 1” 332 can go to one of the filters, Filter(1,1) 334a, . . . , Filter (1,N) 334n, where N is an integer. The filters further divide the frequency band of the processing path into a narrower band of interest. For example, “Filter(1,1)” 334a can be applied to the signal 304 to produce a filtered signal 306, and the filtered signal 306 can be applied to “RF de-multiplexer 1” 336. In some instances, the signal 306 can be amplified in the RF de-multiplexer. The amplified signal 308 can then be input into the spectrum analysis subsystem 305.

Similarly, if “processing path M” 340 is selected as the processing path for the signal 302m, the signal 302m can be fed into “RF multiplexer M” 342. The RF multiplexer can choose between the signal 302m coming from the first RF multiplexer 320 or the RF calibration (cal) tone 348 provided by the spectrum analysis subsystem 305. The output signal of “RF multiplexer M” 342 can go to one of the filters, Filter(M,1) 344a, . . . , Filter (M,N) 344n, where N is an integer. In some instances, the output signal of the filters can be amplified in the RF de-multiplexer M 346. The amplified signal 308m can then be input into the spectrum analysis subsystem 305.

The spectrum analysis subsystem 305 can be configured to convert the detected RF signals into digital signals and perform digital signal processing to identify information based on the detected RF signals. The spectrum analysis subsystem 305 can include one or more SI radio receive (RX) paths (e.g., “Radio RX path 1” 350a, “Radio RX path M” 350m), a DSP spectrum analysis engine 360, an RF calibration (cal) tone generator 370, a front-end control module 380, and an I/O 390. The spectrum analysis subsystem 305 may include additional or different components and features.

In the example shown, the amplified signal 308 is input into “Radio RX path 1” 350a, which down-converts the signal 308 into a baseband signal and applies gain. The down-converted signal can then be digitalized via an analog-to-digital converter. The digitized signal can be input into the DSP spectrum analysis engine 360. In some cases, the DSP spectrum analysis engine 360 includes one or more processor devices, such as, for example, a Forward Error Correction (FEC) device, a Digital Signal Processor (DSP) device, or a combination of these and other types of processor devices. In some cases, the DSP spectrum analysis engine 360 includes a memory device that is shared by one or more of the processor devices. For example, the DSP spectrum analysis engine 360 can include the processor system 110 shown in FIG. 1, the processor system 200 shown in FIG. 2 or another type of processor system that includes a shared memory.

The DSP spectrum analysis engine 360 can, for example, identify packets and frames included in the digital signal, read preambles, headers, or other control information embedded in the digital signal (e.g., based on specifications of a wireless communication standard), determine the signal power and SNR of the signal at one or more frequencies or over a bandwidth, channel quality and capacity, traffic levels (e.g., data rate, retransmission rate, latency, packet drop rate, etc.), or other parameters. The output (e.g., the parameters) of the DSP spectrum analysis engine 360 can be applied and formatted to the I/O 390, for example, for transmission to an external system.

The RF calibration (cal) tone generator 370 can generate RF calibration (cal) tones for diagnosing and calibration of the radio RX paths (e.g., “Radio RX path 1” 350a, . . . “Radio RX path M” 350m). The radio RX paths can be calibrated, for example, for linearity and bandwidth.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications can be made. Accordingly, other embodiments are within the scope of the following claims.

What is claimed is:

1. A wireless sensor device comprising a radio frequency (RF) processor system, the RF processor system comprising:
a shared memory device connected between a forward error correction (FEC) device and a digital signal processor (DSP) device;
the DSP device directly connected to the shared memory device and configured to selectively access individual memory elements of the shared memory device; and
the FEC device directly connected to the shared memory device and configured to collectively access arrays of memory elements of the shared memory device.

2. The wireless sensor device of claim 1, wherein the RF processor system further comprises a translator unit configured to translate memory address information between the FEC device and the shared memory device.

3. The wireless sensor device of claim 1, wherein the shared memory device comprises a matrix of memory elements, the DSP device is configured to access individual memory elements in the matrix, and the FEC device is configured to collectively access rows or columns of memory elements in the matrix.

4. The wireless sensor device of claim 1, comprising an antenna system configured to wirelessly receive radio frequency (RF) signals.

5. The wireless sensor device of claim 4, wherein the RF processor system further comprises one or more processor paths configured to transfer the RF signals from the antenna system to the RF processor system.

6. The wireless sensor device of claim 1, the RF processor system comprising:
multiple shared memory devices connected between multiple FEC devices and multiple DSP devices;
each DSP device directly connected to the shared memory devices and configured to selectively access individual memory elements of the shared memory devices; and
each FEC device directly connected to the shared memory devices and configured to collectively access arrays of memory elements of the shared memory devices.

7. A method of providing memory access in a processor system, the method comprising:
receiving, at a shared memory device connected between a forward error correction (FEC) device and a digital signal processor (DSP) device, a first request from the DSP device to selectively access an individual memory element of the shared memory device;
providing the DSP device access to the individual memory element in response to the first request;
receiving, at the shared memory device, a second request from the FEC device to collectively access an array of memory elements of the shared memory device; and
providing the FEC device access to the array of memory elements in response to the second request.

8. The method of claim 7, wherein the first request to selectively access the individual memory element comprises a request to write information to the individual memory element or a request to read information from the individual memory element.

9. The method of claim 7, wherein the second request to collectively access the array of memory elements comprises a request to write information to the array of memory elements or a request to read information from the array of memory elements.

10. The method of claim 7, further comprising translating memory address information from the FEC device.

11. The method of claim 7, wherein the shared memory device comprises a matrix of memory elements, providing the FEC device access to the array of memory elements comprises providing the FEC device access to a row or column of memory elements in the matrix, and providing the DSP device access to the individual memory element comprises providing the DSP device access to the individual memory element in the matrix.

12. The method of claim 7, further comprising wirelessly receiving radio frequency (RF) signals by operation of an antenna system, and transferring the RF signals from the antenna system to the processor system for analysis.

13. A processor system comprising:
a shared memory device connected between a forward error correction (FEC) device and a digital signal processor (DSP) device;
the DSP device directly connected to the shared memory device and configured to selectively access individual memory elements of the shared memory device; and
the FEC device directly connected to the shared memory device and configured to collectively access arrays of memory elements of the shared memory device.

14. The processor system of claim 13, further comprising a translator unit configured to translate memory address information from the FEC device.

15. The processor system of claim 13, wherein the shared memory device comprises a matrix of memory elements, the DSP device is configured to access individual memory elements in the matrix, and the FEC device is configured to collectively access rows or columns of memory elements in the matrix.

16. The processor system of claim 13, comprising:
multiple shared memory devices connected between multiple FEC devices and multiple DSP devices;
each DSP device directly connected to the shared memory devices and configured to selectively access individual memory elements of the shared memory devices; and
each FEC device directly connected to the shared memory devices and configured to collectively access arrays of memory elements of the shared memory devices.
